(19) United States
(12) Patent Application Publication
(10) Pub. No.: US 2013/0082115 A1
(43) Pub. Date: Apr. 4, 2013

(54) Remote Controlled Vent Register

(71) Applicant: Matthew Ryan May, Katy, TX (US)

(72) Inventors: Matthew Ryan May, Katy, TX (US); Mark Ryan Swearingen, Houston, TX (US)

(73) Assignee: Matthew Ryan May, Katy, TX (US)

(21) Appl. No.: 13/644,142

(22) Filed: Oct. 3, 2012

Related U.S. Application Data
(60) Provisional application No. 61/542,652, filed on Oct. 3, 2011.

(51) Int. Cl. F24F 11/04; G05D 23/19

(52) U.S. Cl. 236/49.3; 236/51

(57) ABSTRACT

A remote controlled air vent register having a mounting plate with a hole; a rotating assembly disposed within the hole, the rotating assembly having a bottom plate and one or more louvers disposed within the bottom plate; a motor statically mounted to a duct-side face of the mounting plate, the motor having a drive shaft and a drive shaft gear mounted to the drive shaft, the drive shaft gear being in geared communication with a geared surface on said rotating assembly; a processor in communication with the motor and powered by a power source; and a receiver within the processor, the receiver being configured to receive a signal from a remote control.

### CROSS REFERENCES TO RELATED APPLICATIONS

This original non-provisional patent application claims the benefit of U.S. provisional patent Application Ser. No. 61/542,652, filed Oct. 3, 2011, entitled “Remote Controlled Vent Register,” which is incorporated by reference herein.

### STATEMENT REGARDING FEDERALLY SPONSORED RESEARCH OR DEVELOPMENT

Not applicable.

### BACKGROUND OF THE INVENTION

1. Technical Field

The present invention generally concerns the heating, ventilation, and air conditioning (HVAC) field. Specifically, the present invention concerns an improved vent register that is remotely adjustable to control the direction of air flow from the register and the amount of air flow through the register.

2. Description of the Related Art

HVAC vent registers come in a variety of shapes and sizes to fit the needs of the HVAC system design and the aesthetic taste of consumers. Regardless of the varied shapes and sizes, most vent registers offer only limited adjustment, if any, for controlling the general direction and amount of air that flows through the louvers on the register.

The general direction of air flow is typically not adjustable. Many registers have one or more groups of louvers aligned in a common general direction. If there are several groups of louvers, the general direction as between each different group may differ. However, the general direction of air flow through each group is established when the register is installed and cannot be changed.

On the other hand, the amount of air that flows through the louvers typically is adjustable, but, must be manually adjusted by physically moving a lever coupled to hinged louvers. The lever usually extends from the face of the register, and, when the register is mounted in hard-to-reach places, such as, for example, the ceiling of a room, the HVAC user must risk his or her safety by climbing a ladder or other object to reach the lever and adjust the amount of air flow.

### BRIEF SUMMARY OF THE INVENTION

The present invention is directed to an improved air vent register that allows a user to remotely control both the general direction of air flow from the register and the amount of air flow through the register. It utilizes a remotely controlled electric motor to turn a drive shaft and a drive shaft gear mounted thereon. The drive shaft gear is in geared communication with a rotating assembly which is rotatably mounted to a static register face and which rotates when driven by the motor. The rotating assembly has one or more grill louvers on it and air from the HVAC system flows through the louvers to condition the room. Thus, the direction of air flow from the vent register can be altered when the rotating assembly is rotated.

The louvers on the rotating assembly may also be hinged and remotely controlled to open and close. Preferably, there is a plurality of louvers and attached to each of the louvers is one or more common levers pivotally coupled to a connecting strut. The connecting strut is a rigid member that extends among a series of corresponding common levers mounted on the same side of the rotating assembly. In the preferred embodiment each louver has one common lever on each of its ends, making two series of common levers, and, a separate connecting strut extends between each of the two series. One of the louvers, referred to as the “activating louver,” is also attached to a main lever which is pivotally coupled to a main strut. The main strut extends from the main lever to an arm that is mounted on a drive shaft of a louver motor.

The louver motor is separate from the electric motor that rotates the rotating assembly. When the louver motor is activated, the arm pushes or pulls the main strut which acts on the main lever to open or close the activating louver. When moved, the activating louver also moves one or more of the common levers that are attached thereto. Movement of a common lever on the activating louver moves the connecting strut coupled thereto and subsequently moves the series of common levers in line with the connecting strut, thereby causing the other louvers on the rotating assembly to open and close.

### BRIEF DESCRIPTION OF THE DRAWINGS

FIG. 1 illustrates a perspective view of the preferred embodiment of the present invention with a partial cutaway of a rotating assembly and plurality of louvers in a closed position.

FIG. 2 shows a top view of the preferred embodiment of present invention with the plurality of louvers in a closed position.

FIG. 3 is a partial side view of the preferred embodiment of the present invention with the plurality of louvers in a closed position.

FIG. 4 is a cross-sectional side view of the preferred embodiment of the present invention, taken along section line 4-4 in FIG. 2, with the plurality of louvers in an open position.

FIG. 5 is a bottom view of the preferred embodiment of the present invention with the plurality of louvers in a closed position.

### DETAILED DESCRIPTION OF THE INVENTION

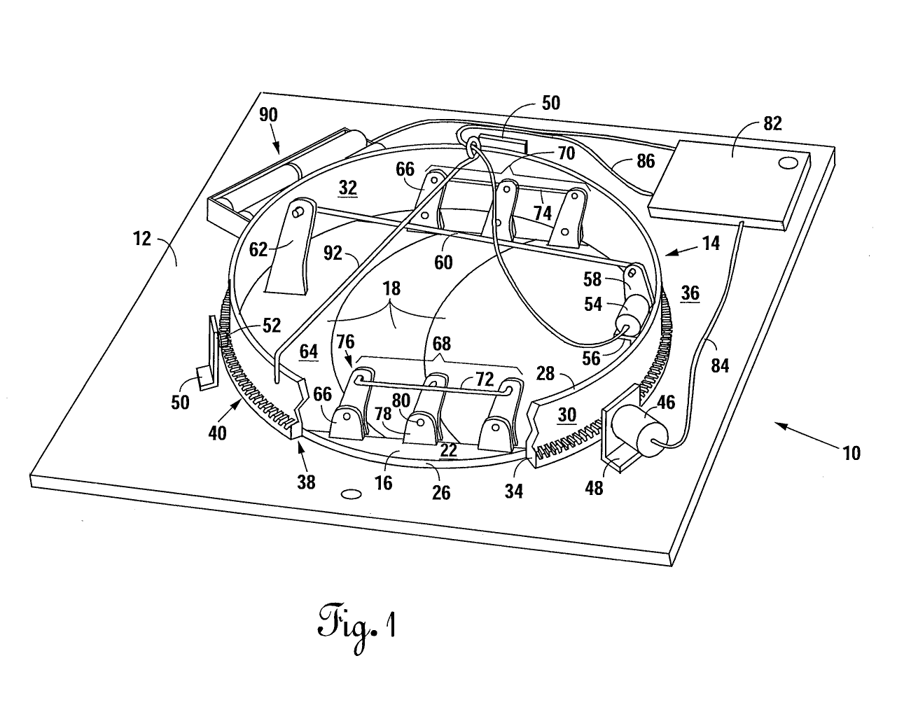

Referring to FIGS. 1 & 2, the preferred embodiment of the present invention is shown. FIG. 1 shows a perspective view of a vent register 10 with a mounting plate 12 and a rotating assembly 14 mounted thereon. The rotating assembly 14 has a bottom plate 16 that contains one or more grill louvers 18. Preferably, the bottom plate 16 is at least partially located within a hole 20 through the mounting plate 12 (see FIG. 5), but, it could be above (i.e., toward a duct (not shown)) or below (i.e., toward a room (not shown) being conditioned) the hole 20.

The bottom plate 16 has a duct-side face 22, a room-side face 24 (see FIG. 5), and a side perimeter 26 therebetween. The duct-side face 22 is the side toward the incoming air flow to the vent register 10. A circular sidewall 28 extends from the bottom plate 16, preferably along the side perimeter 26. Alternatively, sidewall 28 could extend from the duct-side face 22 of the bottom plate 16 or even the room-side face 24 of the bottom plate 16. In addition, sidewall 28 may be a separately manufactured piece affixed to the bottom plate 16, or, sidewall 28 and bottom plate 16 may be manufactured from a single integral piece of material.

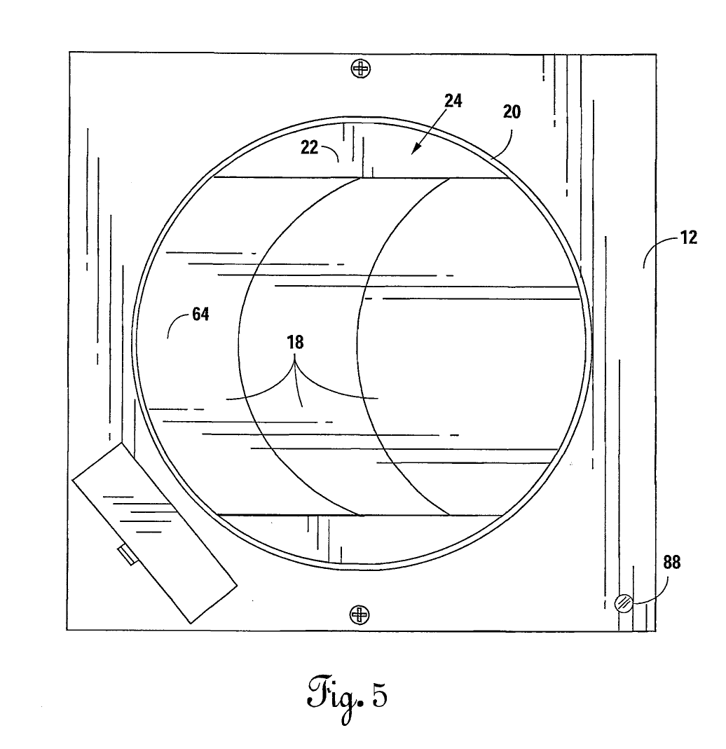

Sidewall 28 has an outer wall 30 that faces toward the perimeter of the mounting plate 12 and an inner wall 32 facing opposite the direction the outer wall 34 faces. A lip 34 protrudes from the outer wall 30 and extends at least partially over a duct-side face 36 of the mounting plate 12. At least a portion 38 of lip 34 preferably rests on the duct-side face 36 of the mounting plate 12, as shown in FIG. 4.

Lip 34 has a geared surface 40 disposed on it. Preferably, the geared surface 40 is disposed on the lip 34 opposite of the portion 38 that rests on the duct-side face 36 of the mounting plate 12. The geared surface 40 extends along the lip 34 and around the outer wall 30 of the sidewall 28. Preferably, the geared surface 40 extends around the entire circumference of the outer wall 30 though it does not have to. As will be seen, the length of the geared surface 40 around the outer wall 30 may determine the amount of rotation that the rotating assembly 14 can achieve.

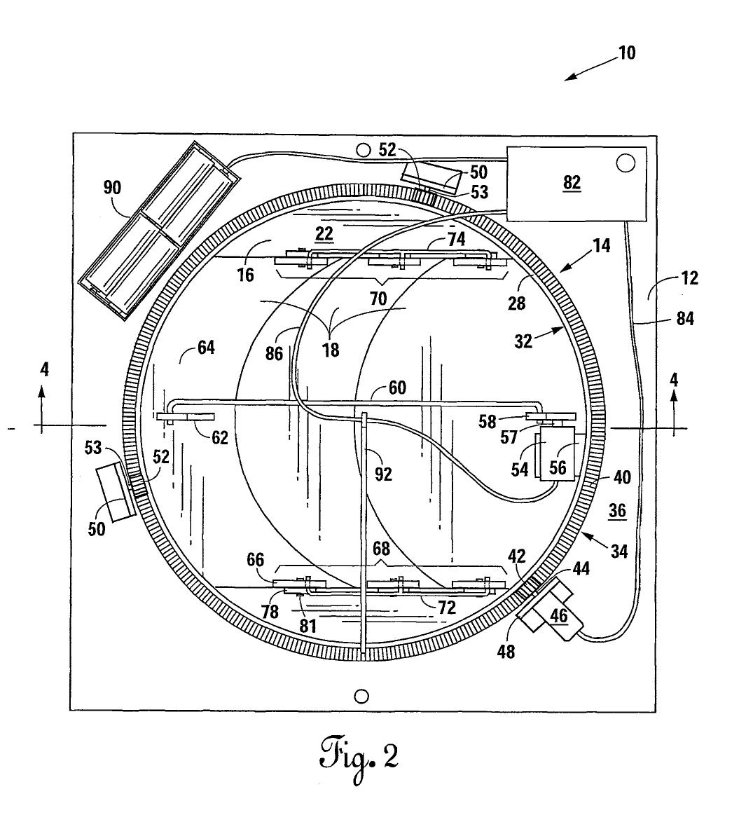

A drive shaft gear 42 (see FIG. 2) positioned on a drive shaft 44 of an electric motor 46 is in geared communication with the geared surface 40 of the lip 34. The electric motor 46 is mounted to a motor mount 48 on the duct-side face 36 of the mounting plate 12. The exact location of the motor mount 48 on the duct-side face 36 of the mounting plate 12 is a design choice. Additionally, the motor mount 48 may be a separately manufactured piece affixed to the mounting plate 12, or, motor mount 48 and mounting plate 12 may be manufactured from a single integral piece of material.

In the preferred embodiment, one or more stabilizing mounts 50 are located on the duct-side face 36 of the mounting plate 12. The exact positioning of the stabilizing mounts 50 in relation to the motor mount 48 is a design choice but, preferably, the stabilizing mounts 50 and the motor mount 48 are positioned equidistant from one another so as to create a uniform distance between each of the elements. Like the motor mount 48, the stabilizing mounts 50 also may be separately manufactured pieces affixed to the mounting plate 12, or, the stabilizing mounts 50 and mounting plate 12 may be manufactured from a single integral piece of material. A stabilizing gear 52 is mounted on an axle 53 that extends from each of the one or more stabilizing mounts 50 toward the outer wall 30 of the sidewall 28. The stabilizing gear 52 of each of the stabilizing mounts 50 is in geared communication with the geared surface 40 of the lip 34.

In the preferred embodiment, the louvers 18 within the bottom plate 16 are also remotely controlled, though they do not have to be. To enable remote control of the louvers 18, certain additional elements are present. An electric louver motor 54 is mounted to a louver motor mount 56. The louver motor mount 56 preferably extends from the inner wall 32 of the sidewall 28 though it could extend from elsewhere on the sidewall 28. The louver motor mount 56 may be a separately manufactured piece affixed to the sidewall 28, or, louver motor mount 56 and sidewall 28 may be manufactured from a single integral piece of material.

A drive shaft 57 extends from the electric louver motor 54 (see FIG. 2), and, a moveable arm 58 is attached to the drive shaft 57. A rigid main strut 60 is pivotally coupled to the arm 58 and extends from the arm 58 toward the opposite side of the rotating assembly 14. Main strut 60 terminates at and is pivotally coupled to a main lever 62 that extends from an activating louver 64.

Activating louver 64 also has one or more common levers 66 extending from it. Preferably, there are two common levers 66 on the activating louver 64, with one of the common levers 66 being at each end of the activating louver 64. At least one of the common levers 66 on the activating louver 64 is aligned with corresponding common levers 66 extending from the other louvers 18 and forms a first series 68 of common levers 66. In the preferred embodiment, the second of the common levers 66 on the activating louver 64 is also aligned with corresponding common levers 66 extending from the other louvers 18 and a second series 70 of common levers 66 is formed.

A rigid first connecting strut 72 extends among and is pivotally coupled to each of the common levers 66 in the first series 68. In the preferred embodiment, a second rigid connecting strut 74 also extends among and is pivotally coupled to each of the common levers 66 in the second series 70. Preferably, the first and second connecting struts 72, 74 extend among their corresponding series of common levers 66 along a top end 76 of the common levers 66, with the top end 76 being opposite of where the common levers 66 extend from the louvers 18.

Each of the louvers 18 (including the activating louver 64) is pivotally connected to the bottom plate 16 of the rotating assembly 14. Preferably, each of the louvers 18 is hinged to the bottom plate 16 through their common levers 66. In this regard, each of the common levers 66 is adjacent a corresponding hinge mount 78 which extends from the bottom plate 16. Each of the common levers 66 and its corresponding hinge mount 78 has aligned pivot holes 80 that have a hinge pin 81 (see FIG. 2) inserted therein, and, the louvers 18 are pivotable about their respective hinge pin 81.

The electric motor 46 and the louver motor 54 are controlled by a processor 82 which is communicated with the electric motor 46 and the louver motor 54. For simplicity, processor 82 is preferably connected to the electric motor 46 via a first wire 84 and connected to the louver motor 54 via a second wire 86 and communicates with these elements via the wires 84, 86. However, it is anticipated that processor 82 may communicate with electric motor 46 and louver motor 54 via wireless communication in alternative embodiments.

To operate the system, a remote control (not shown) transmits a signal to the processor 82. Preferably, the signal is optically communicated from the remote control (not shown) to an infrared receiver 88 on the room-side face 24 of the vent register 10 mounting plate 12 (see FIG. 5). Alternatively, the signal may be communicated via some other type of wireless communication or via a hard-wired signal, such as, for example, with a wall switch. After receiving the signal, the processor 82 processes it and activates the electric motor 46, the louver motor 54, or both.

The electric motor 46, the louver motor 54, and the processor 82 are preferably powered through a battery pack 90. The battery pack 90 is wired to the processor 82 and the processor 82 distributes power to the electric motor 46 and/or the louver motor 54 depending on the signal received from the remote control (not shown). The battery pack 90 and battery powered operation allows existing HVAC systems to be retrofit with the present invention. Alternatively, the present invention may be wired into a structure during construction so that it is powered by the electric service which powers the structure.

To rotate the rotating assembly 14, the processor 82 receives an appropriate signal from the remote control (not shown) and the electric motor 46 is activated. The electric motor 46 rotates the drive shaft 44 and the drive shaft gear 42 located thereon. As the drive shaft gear 42 turns, the geared communication of the drive shaft gear 42 and the geared surface 40 of the lip 34 causes the rotating assembly 14 to rotate. As it rotates, the portion 38 of the lip 34 that rests on the duct-side face 36 of the mounting plate 12 slides along the mounting plate 12 and prevents the rotating assembly 14 from falling out of the hole 20 in the mounting plate 12. In addition, the stabilizing gear 52 on each stabilizing mount 50 helps keep the rotating assembly 14 aligned during rotation.

To prevent tangling, the rotating assembly 14 preferably will rotate a preset distance before being stopped. In particular, limiting the rotation of the rotating assembly 14 prevents the second wire 86 from becoming tangled when the louver motor 54 is present. Mechanical stops (not shown) may be placed on the geared surface 40 of the lip 34, the length of the geared surface 40 may be shortened, or processor 82 may be programmed to limit the rotation. Optimally, rotation of the rotating assembly 14 is limited to 360° so that a full rotation may be achieved. Moreover, an arm 92 is present in the preferred embodiment to hold the second wire 86 away from elements within the rotating assembly 14 that could create tangling.

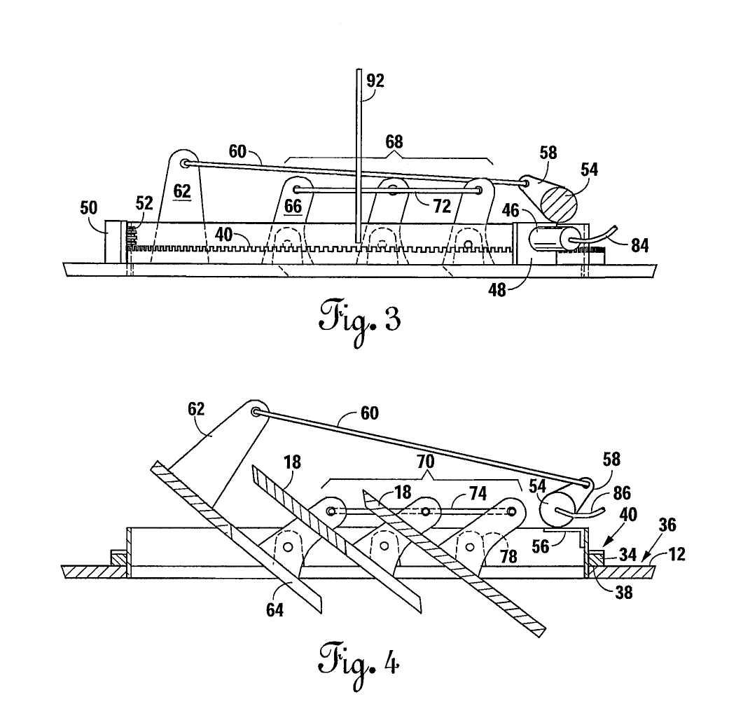

Operation of the louver motor 54 is also activated by the processor 82. After receiving the appropriate signal from the remote control (not shown), the processor 82 instructs the louver motor 54 to rotate its drive shaft 57 one way or the other. The arm 58 connected to the drive shaft 57 of the louver motor 54 moves toward or away from the main lever 62 depending, respectively, on whether the louvers 18 are being opened or closed. When being opened, the rigid main strut 60 pulls the main lever 62 toward the louver motor 54 (see FIG. 4) and, when being closed, pushes the rigid main strut 60 away from the louver motor 54 (see FIG. 3).

Pushing and/or pulling the main lever 62 with the main strut 60 causes the activating louver 64 to be rotated about its pivotal connection with the bottom plate 16 of the rotating assembly 14. In turn, the common levers 66 on each end of the activating louver 64 are also rotated and the rigid first and second connecting struts 72, 74 push and/or pull each of the common levers 66 in the first and second series 68, 70, respectively. Pushing and/or pulling of the first and second series 68, 70 of common levers 66 by their respective connecting struts 72, 74, causes the non-activating louvers 18 connected to the common levers 66 to rotate as well.

Although the present invention has been described with reference to specific embodiments, this description is not meant to be construed in a limiting sense. Various modifications of the disclosed embodiments, as well as alternative embodiments of the invention will become apparent to persons skilled in the art upon the reference to the above description of the invention. It is, therefore, contemplated that the appended claims will cover such modifications that fall within the scope of the invention.

1. A remote controlled air vent register comprising:
a mounting plate with a hole;
a rotating assembly disposed within said hole, said rotating assembly having a bottom plate and one or more louvers disposed within said bottom plate;
a motor statically mounted to a duct-side face of said mounting plate, said motor having a drive shaft and a drive shaft gear mounted to said drive shaft,
said drive shaft gear being in geared communication with a geared surface on said rotating assembly
a processor communicated with said motor, said processor being powered by a power source; and,
a receiver within said processor, said receiver being configured to receive a signal from a remote control.

2. The remote controlled air vent register of claim 1 comprising:
a louver motor mounted to said rotating assembly, said louver motor being communicated with said processor;
an arm mounted to a drive shaft extending from said louver motor; and,
a main strut connected to and extending from said arm, said main strut extending to a main lever which extends from an activating louver, said activating louver being pivotally connected to the bottom plate of said rotating assembly.
